(19) United States
(12) Patent Application Publication
(10) Pub. No.: US 2009/0145667 A1
(43) Pub. Date: Jun. 11, 2009

(54) ACTIVE STABILIZATION DURING CUTTING FOR HOLE OPENING TOOLS

(75) Inventors: Navish Makkar, Houston, TX (US); Gordon Whipple, Spring, TX (US); Tommy Laird, Cypress, TX (US)

Correspondence Address: OSHA, LIANG LLP / SMITH, TWO HOUSTON CENTER, 909 FANNIN STREET, SUITE 3500, HOUSTON, TX, 77010, US

(73) Assignee: SMITH INTERNATIONAL, INC., Houston, TX (US)

(21) Appl. No.: 11/950,722

(22) Filed: Dec. 5, 2007

(51) Int. Cl. E21B 10/26; B23D 63/00

(52) U.S. Cl. 175/391; 76/108.4

(57) ABSTRACT

A drilling tool for drilling a wellbore that includes at least a reaming section and a pilot conditioning section. The pilot conditioning section then includes at least one pilot conditioning blade having at least one cutting element formed of an impregnated matrix material. An outermost extent of the at least one cutting element from a central axis of the tool body is at least half of a pilot hole diameter.

### BACKGROUND OF INVENTION

1. Field of the Invention

Embodiments disclosed herein relate generally to cutting tools used to drill wellbores in the earth. More specifically, embodiments disclosed herein relate generally to drilling tools having reaming sections and pilot sections, in which a pilot conditioning section is disposed therebetween.

2. Description of the Related Art

Drill bits that drill holes through earth formations where the hole has a larger diameter than the bit's pass-through diameter (the diameter of an opening through which the bit can freely pass) are known in the art. Early types of such bits included so-called “underreamers,” which were essentially a drill bit having an axially elongated body and extensible arms on the side of the body which reamed the wall of the hole after cutters on the end of the bit had drilled the earth formations. Mechanical difficulties with the extensible arms limited the usefulness of underreamers.

More recently, so-called “bi-centered” drill bits have been developed. A typical bi-centered drill bit includes a “pilot” section located at the end of the bit, and a “reaming” section which is typically located at some axial distance from the end of the bit (and consequently from the pilot section). One such bi-centered bit is described in U.S. Pat. No. 5,678,644 issued to Fielder, for example. Bi-centered bits drill a hole larger than their pass through diameters because the axis of rotation of the bit is displaced from the geometric center of the bit. This arrangement enables the reaming section to cut the wall of the hole at a greater radial distance from the rotational axis than is the radial distance of the reaming section from the geometric center of the bit. The pilot section of the typical bi-centered bit includes a number of PDC cutting elements attached to structures (“blades”) formed into or attached to the end of the bit. The reaming section is, as already explained, typically spaced axially away from the end of the bit, and is also located to one side of the bit. The reaming section also typically includes a number of PDC inserts on blades on the side of the bit body in the reaming section.

Limitations of the bi-centered bits known in the art include the pilot section being axially spaced apart from the reaming section by a substantial length. FIG. 1 shows a side view of one type of bi-center bit known in the art, which illustrates this aspect of prior art bi-center bits. The bi-center bit 101 includes a pilot section 106, which includes pilot blades 103 having PDC inserts 110 disposed thereon, and includes gage pads 112 at the ends of the pilot blades 103 axially distant from the end of the bit 101. A reaming section 107 can include reaming blades 111 having polycrystalline diamond compact (PDC) inserts 105 thereon and gage pads 117 similar to those on the pilot section 106. In the bi-center bit 101 known in the art, the pilot section 106 and reaming section are typically separated by a substantial axial distance, which can include a spacer or the like such as shown at 102. Spacer 102 can be a separate element or an integral part of the bit structure, but is referred to here as a “spacer” for convenience. As is conventional for drill bits, the bi-center bit 101 may include a threaded connector 104 machined into its body 114. The body 114 may further include wrench flats 115 or the like for make up to a rotary power source such as a drill pipe or hydraulic motor.

In FIG. 2, a later improvement to bi-centered bits is shown. Such a bi-centered bit is disclosed in U.S. Pat. No. 6,659,207, which is assigned to the assignee of the present application and incorporated herein by reference in its entirety. A bi-center drill bit 10 includes a body 18, which can be made from steel or any other material conventionally used for drill bit bodies. The upper end of the body 18 includes a threaded connection 20 for attaching the bit 10 to a source of rotary power, such as a rotary drilling rig (not shown) or hydraulic motor (not shown) so that the bit 10 can be turned to drill earth formations (not shown).

At the end of the body 18 opposite the threaded connection 20 is a pilot section 13 of the bit 10. The pilot section 13 includes a set of azimuthally spaced apart blades 14 affixed to or otherwise formed into the body 18. On each of the blades 14 is mounted a plurality of PDC inserts, called cutters or cutting elements, such as shown at 12. The pilot blades 14 typically each extend laterally from the longitudinal axis 24 of the bit 10 by the same amount. The pilot section 13 thus has a drilling radius, which can be represented by RP (14A in FIG. 2) of about the lateral extent of the pilot blades 14. The radially outermost surfaces of the pilot blades 14 generally conform to a circle which is substantially coaxial with the longitudinal axis 24 of the bit 10. When the bit 10 is rotated about its longitudinal axis 24, the pilot section 13 will thus drill a hole having a diameter about equal to two of the RP. Further, the pilot hole diameter may be maintained by gage pads, such as shown in FIG. 2 at 14G, disposed on the radially (laterally) outermost portion of the pilot blades 14.

A reaming section 15 is positioned on the body 18 axially spaced apart from the pilot section 13. The reaming section 15 includes a plurality of blades 16 each having thereon a plurality of PDC cutters 12. The reaming blades 16 are formed into the body 18 just as the pilot blades 14. The axial spacing referred to between the pilot section 13 and the reaming section 15 denotes the space between the axial positions along the bit 10 at which actual cutting of earth formations by the bit 10 takes place. The pilot section 13 and reaming section 15 are a unitized spiral structure for some of the blades 14, 16. Some of the blades 16 in the reaming section 15 extend a maximum lateral distance from the rotational axis 24 of the bit 10 which can be represented by RR (16A in FIG. 2), and which is larger than RP.

The bit 10 shown in FIG. 2 has a “pass-through” diameter (the diameter of an opening through which the bit 10 will fit), which results from forming the reaming blades 16 to conform to a circle having the pass-through diameter. The center of the pass through circle, however, is offset from the longitudinal axis 24 of the bit. As a result of forming the blades 16 to conform to the axially offset pass-through circle, some of the reaming blades 16, such as shown at 16F in FIG. 2, will not extend laterally from the axis 24 as much as the other reaming blades. The laterally most extensive ones of the reaming blades 16 thus formed may include gage pads such as shown at 16G. During drilling, as the bit 10 is rotated about the longitudinal axis 24, the hole which is drilled by the reaming section 15 will have a diameter about equal to two of the RR as the blades 16 in the reaming section 15, which extend the full lateral distance RR from the longitudinal axis 24, rotate about the longitudinal axis 24. The bit 10 also includes a plurality of jets 22.

The '207 Patent also discloses what is termed a “pilot conditioning section,” as shown in FIG. 3. A cross-section of an example blade structure with a pilot conditioning section 17 is shown in FIG. 3. Only the portion extending from the pilot section 13 to the reaming section 16 is illustrated. The blade B4B, shown in cross section FIG. 3, includes a tapered face 17A and a gage face 17G. A plurality of cutting elements 12, which may be PDC cutters as are the other cutting elements on the bit, are disposed on the tapered face 17A. The intermediate diameter gage face 17G is disposed below the tapered face 17A and may include thereon any form of gage protection (not shown) known in the art, or may include at least one cutting element (not shown in this example) disposed at an intermediate gage diameter defined by the gage face 17G. The tapered face 17A, having cutting elements 12 thereon, and the intermediate diameter gage face 17G are included on a plurality of the blades azimuthally distributed around the circumference of the bi-center bit. The longitudinal position of the tapered face 17A and gage face 17G is generally between the pilot section 13 and the reaming section 16. The tapered face 17A and gage face 170 are formed into the same blade structure as selected ones of the pilot blades 14 or reaming blades 16. In combination, the intermediate diameter gage faces 17G and the tapered faces 17A, distributed azimuthally around the bit, form the pilot hole conditioning section 17 disposed longitudinally between the pilot section 13 and the reaming section 16 on the bi-center bit. Having the pilot hole conditioning section 17, such as shown in FIG. 3, may improve the ability of a bi-center bit to “hold angle” or otherwise maintain intended wellbore trajectory when used in directional drilling applications.

An analogous pilot conditioning section for a hole opener, shown in FIG. 4, is disclosed in U.S. Pat. No. 6,742,607, which is assigned to the assignee of the present application and incorporated herein by reference in its entirety. The hole opener 80 includes a pilot conditioning section 82 positioned proximate a cutting structure 92 formed on the hole opener 80 (e.g., proximate blades 90). The blades 85 in the pilot conditioning section 82 each include a taper 98 on their “downhole” ends (e.g., the ends nearest threaded connection 97). The blades 85 may be spiraled or straight. The tapers 98 substantially align the hole opener 80 with the existing wellbore (e.g., with a hole drilled by a pilot bit (not shown)).

Pilot gage pads 94 in the pilot conditioning section 82 help to maintain concentric alignment of the hole opener 80 in the wellbore (not shown). Cutting elements 84 in the pilot hole conditioning section 82 are positioned so as to drill a hole having a slightly larger intermediate diameter D2 than a nominal diameter of the pilot bit that, for example, drilled the existing wellbore. For example, if the pilot bit has an 8.5 inch (215.9 mm) diameter, the cutting elements 84 can be laterally positioned along the pilot hole conditioning section blades 85 to drill an intermediate diameter D2 having an approximately 9 inch (228.6 mm) diameter. The intermediate diameter D2 may be maintained by intermediate gage pads 93 positioned axially “uphole” (e.g., away from the pilot bit) from the cutting elements 84. The cutting elements 84 and the intermediate gage pads 93 provide a substantially smooth, round, selected diameter thrust surface against which the hole opener 80 may drill a hole having the selected drill diameter D3.

However, despite improvements in bi-center bits and hole openers as a result of pilot conditioning sections, there is a continued need to improve directional stability while increasing the diameter of the wellbore formed by the pilot section or drill bit.

### SUMMARY OF THE INVENTION

In one aspect, embodiments disclosed herein relate to a drilling tool including a tool body, in which the tool body includes a connection at the upper end thereof. The drilling tool then further includes a reaming section and a pilot conditioning section. The reaming section includes reaming blades distributed azimuthally around the tool body, in which the reaming blades are configured to increase the diameter of a wellbore from a pilot hole diameter. Further, the pilot conditioning section includes pilot conditioning blades distributed azimuthally around the tool body and disposed below the reaming section, in which at least one of the pilot conditioning blades includes at least one cutting element formed of an impregnated matrix material and an outermost extent of the at least one cutting element from a central axis of the tool body is at least half of the pilot hole diameter.

In another aspect, embodiments disclosed herein relate to a drilling tool having a tool body with a central axis extending therethrough. The tool includes a pilot section, a pilot conditioning section, and a reaming section. The pilot section includes pilot blades distributed azimuthally around the tool body, in which the pilot blades define a pilot diameter. The pilot conditioning section includes pilot conditioning blades distributed azimuthally around the tool body and disposed above the pilot section, in which the pilot conditioning blades include at least one cutting element formed of a matrix material and an abrasive material, wherein the pilot conditioning blades define a pilot conditioning diameter. The reaming section includes comprising reaming blades distributed azimuthally around the tool body, in which the reaming blades define a reaming diameter. The pilot conditioning diameter is between the range of, and including, the pilot diameter and a pass-through diameter.

In yet another aspect, embodiments disclosed herein relate to a drilling tool with a central axis extending therethrough. The tool includes a pilot section, a pilot conditioning section, and a reaming section. The pilot section is configured to form a wellbore with a pilot hole diameter and the reaming section is to increase the diameter of the wellbore to a reaming hole diameter, in which the reaming section is disposed above the pilot section. Further, the pilot conditioning section is disposed between the pilot section and the reaming section, in which the pilot conditioning section includes a cutting element formed of an impregnated matrix material and configured to engage the wellbore with a pilot conditioning hole diameter between and including the reaming hole diameter and the pilot hole diameter.

In yet another aspect, embodiments disclosed herein relate to a method of forming a drilling tool for drilling through a formation to form a wellbore. The method includes providing a body for the drilling tool, in which the body includes a pilot conditioning section having at least one pilot conditioning blade and a reaming section having at least one reaming blade. The method further includes affixing to the reaming blade at least one cutting element and affixing to the pilot conditioning blade at least cutting element formed of an impregnated matrix material.

Other aspects and advantages of the invention will be apparent from the following description and the appended claims.

### BRIEF DESCRIPTION OF DRAWINGS

FIG. 1 shows a prior art bi-center drill bit.

FIGS. 2 and 3 show a prior art bi-center drill bit having a pilot conditioning section.

FIG. 4 shows a prior art hole opener having a pilot conditioning section.

FIGS. 5A and 5B show cross-sections of a drilling tool in accordance with embodiments disclosed herein.

FIGS. 6A and 6B show perspective views of a drilling tool in accordance with embodiments disclosed herein.

FIGS. 7A and 7B show a profile view and a perspective view of a drilling tool in accordance with embodiments disclosed herein.

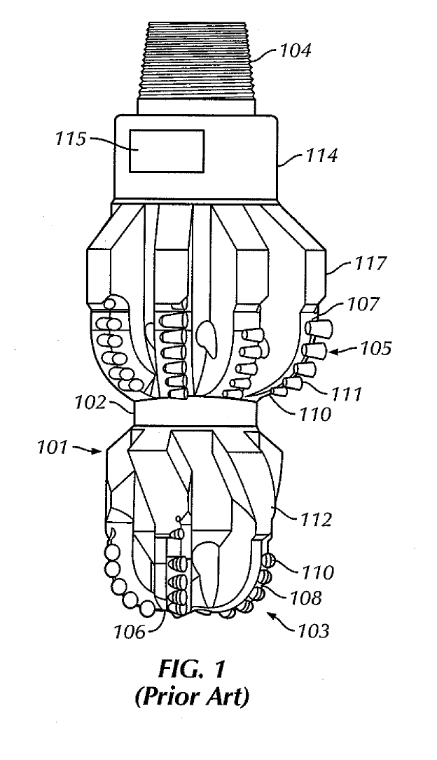

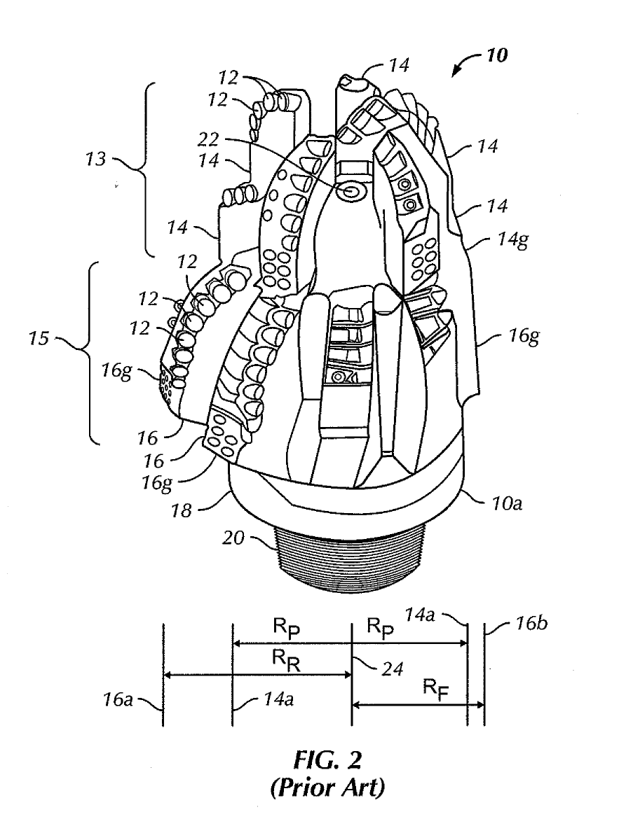

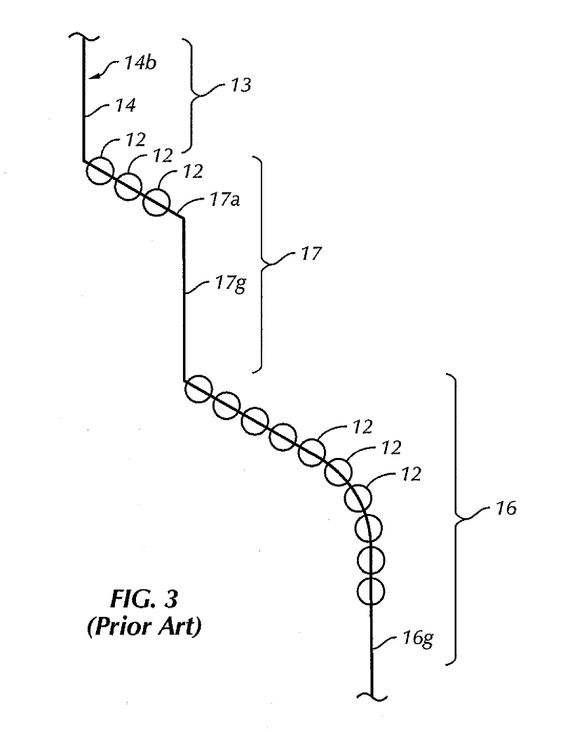

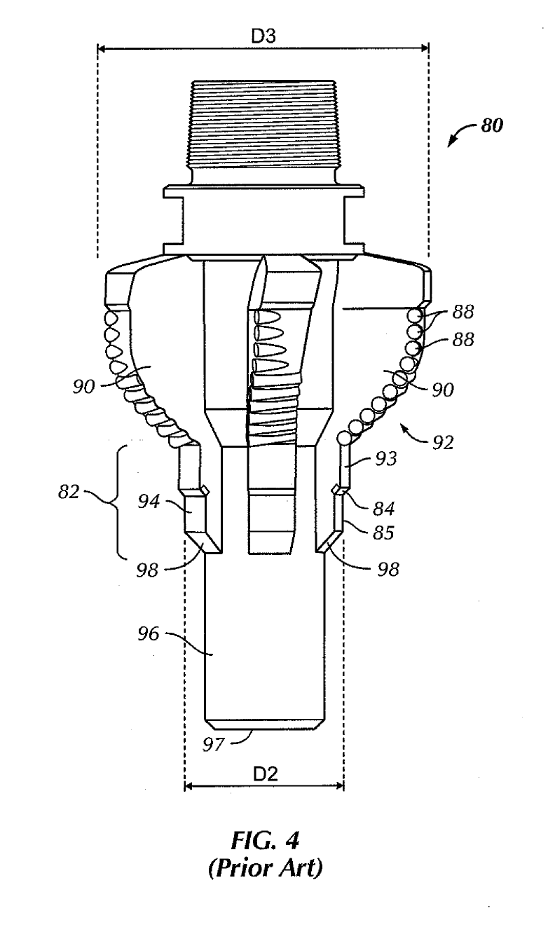

### DETAILED DESCRIPTION

Specific embodiments of the present disclosure will now be described in detail with reference to the accompanying figures. Like elements in the various figures may be denoted by like reference numerals for consistency.

In the following detailed description of embodiments of the present disclosure, numerous specific details are set forth in order to provide a more thorough understanding of the disclosure. However, it will be apparent to one of ordinary skill in the art that the embodiments disclosed herein may be practiced without these specific details. In other instances, well-known features have not been described in detail to avoid unnecessarily complicating the description.

Embodiments disclosed herein relate to a drilling tool having a body with a pilot conditioning section. The drilling tool may also include a pilot section disposed below the pilot conditioning section (in relation to the drilling tool when drilling a wellbore), and a reaming section disposed above the pilot conditioning section. As such, the pilot conditioning section will follow the path formed within the wellbore by the pilot section. Further, the pilot conditioning section includes one or more pilot conditioning blades, in which one or more cutting elements formed of an impregnated matrix material are attached or affixed thereto.

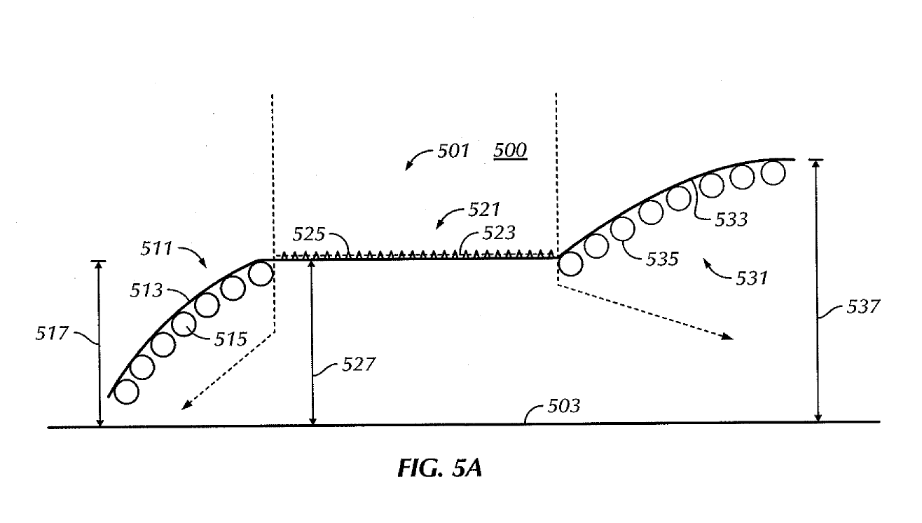

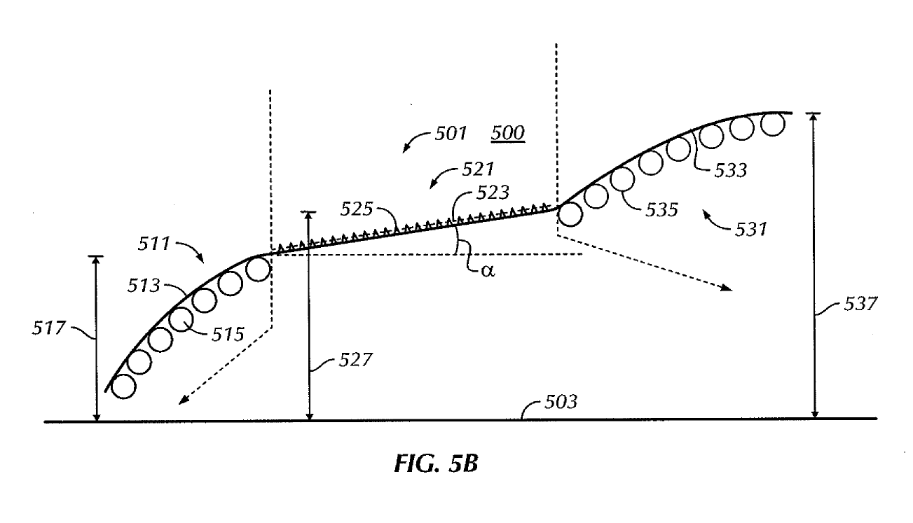

Referring now to FIGS. 5A and 5B, a cross-section of an example blade structure of a drilling tool 501 in accordance with embodiments disclosed herein is shown. In this embodiment, the drilling tool 501 includes a pilot section 511, a pilot conditioning section 521, and a reaming section 531. The pilot section 511 includes a pilot blade 513, the pilot conditioning section 521 includes a pilot conditioning blade 523, and the reaming section 531 includes a reaming blade 533. Further, the pilot blade 513, the pilot conditioning blade 523, and the reaming blade 533 may be formed into a unitized blade structure (discussed more below).

Further, each of the pilot, pilot conditioning, and reaming blades may include one or more various types of cutting elements affixed thereto or disposed thereon for cutting. Among the types of cutting elements that may be affixed to the blades 513, 523, 533 include polycrystalline diamond compacts (PDCs), polycrystalline cubic boron nitride (PCBN) cutting elements, diamond impregnated inserts, such as those described in U.S. Pat. No. 6,394,202 and U.S. Patent Publication No. 2006/0081402, which are assigned to the present assignee and herein incorporated by reference in their entirety, and various shearing elements that may be formed from polycrystalline diamond, PCBN, thermally stable polycrystalline diamond (TSP), such as those described in U.S. Patent Publication Nos. 2005/0133278 and 2006/0032677, which are also both assigned to the present assignee and herein incorporated by reference in their entirety. For example, as shown in FIGS. 5A and 5B, the pilot blade 513 and the reaming blade 533 each include PDC cutting elements 515 and 535, respectively, and the pilot conditioning blade 523 include one or more impregnated matrix cutting elements 525 (discussed more below).

The pilot blade 513 then has a pilot radius 517, which corresponds to the distance of the outermost cutting element 515 from the central axis 503. This allows the pilot blade 513 to define a pilot diameter, which is equivalent to about twice the distance as shown by the pilot radius 517. Specifically, the pilot diameter refers to the diameter of the pilot blade 513 as the drilling tool 501 is rotated. As such, the pilot diameter defined by the pilot blade 513 of the pilot section 511 would be twice the distance as shown by the pilot radius 517. When the drilling tool 501 is then rotated about the central axis 503 to drill a wellbore 500, the pilot blade 513 will drill the wellbore 500 with a pilot hole diameter approximately equal to the pilot diameter of the pilot blade 513.

Similar to the pilot blade 513, the pilot conditioning blade 523 of the pilot conditioning section 521 has a pilot conditioning radius 527, and the reaming blade 533 of the reaming section 531 has a reaming radius 537. These radii 527 and 537 define a diameter for each of the pilot conditioning and reaming blades 523 and 533, respectively, as the drilling tool 501 is rotated. Then, as the drilling tool 501 is rotated about the central axis 503, the pilot conditioning blade 523 will drill the wellbore 500 with a pilot conditioning hole diameter approximately equal to the pilot conditioning diameter, and the reaming blade 533 will drill the wellbore 500 with a reaming hole diameter approximately equal to the reaming diameter.

As shown in FIG. 5A, the pilot conditioning radius 527 is slightly larger than the pilot radius 517. However, those having ordinary skill in the art will appreciate that the pilot conditioning radius may vary between the range of, and including, the pilot radius and the reaming radius. Therefore, in another embodiment, the outermost extent of the impregnated matrix cutting element 525 disposed on the pilot conditioning blade 523 is at least that of the pilot radius 517. Preferably though, rather than having the pilot conditioning radius vary between the range, and including, the pilot radius and the reaming radius, the pilot conditioning radius varies between the range, and including, the pilot radius and a pass-through radius. As described above, a drilling tool having a reaming section and a pilot section may have a pass-through diameter (the diameter of an opening through which the drilling tool may freely pass-through). The pass-through radius, which corresponds to the pass-through diameter by halt is larger than the pilot radius, but is usually smaller than the reaming radius. Therefore, in one embodiment of the present disclosure, the pilot conditioning radius may be between the range of, and including, the pilot radius and the pass-through radius.

Further, to increase the pilot conditioning radius 527, the pilot conditioning blade 523 may include a taper or a tapered section. For example, as shown in FIG. 5B, the pilot conditioning blade 523 may include a taper at an angle a of about 10 degrees. By including a taper or a tapered section within the pilot conditioning blade 523, the pilot conditioning radius 527 may be increased, corresponding to the length of the tapered section and the angle of the taper. Preferably though, to prevent too much torque from being transmitted to the pilot conditioning blade 523, the taper is no larger than about 5 degrees.

Furthermore, to prevent too large of a pilot conditioning radius 527 from being manufactured, preferably the pilot conditioning radius 527 is no larger than about 10 percent of the pilot radius 517. More preferably, the pilot conditioning radius 527 is no larger than about 5 percent of the pilot radius 517. Therefore, for example, if the pilot radius 517 is about 10 inches (254 mm), the pilot conditioning radius 527 is no larger than about 10.5 inches (267 mm). Accordingly, if the pilot conditioning radius 527 is no larger than about 5 percent of the pilot radius 517, the outermost extent of the impregnated matrix cutting element 525 disposed on the pilot conditioning blade 523 is no larger than about 5 percent of the pilot radius 517.

Further, as shown in FIGS. 5A and 5B and discussed above, the pilot blade 513, pilot conditioning blade 523, and the reaming blade 533 may be formed as a unitized blade structure. The Applicants have found that a unitized blade structure may increase the stability of the drilling tool during drilling. For example, a unitized blade structure may be able to enable the drilling tool to have smoother transitions in applied torque between each of the sections. Specifically, rather than having a gap between each of the sections, a unitized blade structure will enable the drilling tool to have continuous contact with the wellbore.

Those having ordinary skill in the art will appreciate that, though the pilot blade, pilot conditioning blade, and the reaming blade may be formed as a unitized blade structure, the present disclosure is not so limited, and each of these blades may be formed individually. Further, rather than being formed individually, those having ordinary skill in the art will appreciate that the pilot conditioning blade may be formed into a unitized blade structure with one of the other two blades. For example, in one embodiment, the pilot blade and the pilot conditioning blade may be formed into a unitized blade structure, and the reaming blade may be formed individually. Furthermore, because FIGS. 5A and 5B show an example of a blade structure, only one unitized blade structure may be shown, However, those having ordinary skill in the art will appreciate that the present disclosure is not so limited, and the drilling tool may include multiple unitized blade structures, in addition to multiple pilot blades, pilot conditioning blades, and reaming blades. As such, when the drilling tool includes more than one pilot blade, pilot conditioning blade, and/or reaming blade, the blades may be distributed azimuthally around a body of the drilling tool, as is known in the art, to facilitate drilling of the drilling tool.

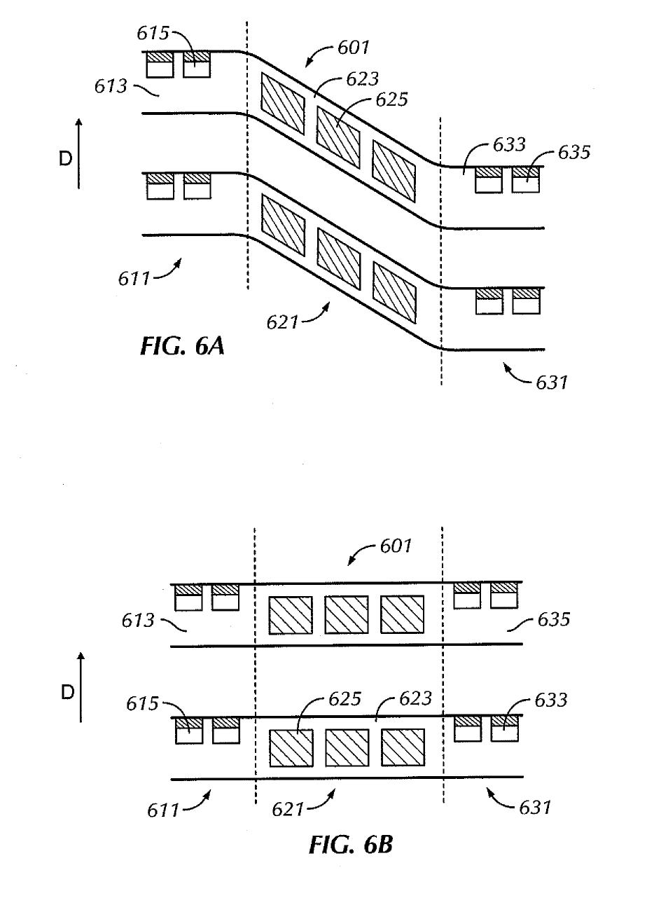

Referring now to FIGS. 6A and 6B, perspective views of a drilling tool 601 in accordance with embodiments disclosed herein are shown. As similar to above, the drilling tool 601 includes a pilot section 611, a pilot conditioning section 621, and a reaming section 631. Further, the pilot section 611 includes a pilot blade 613, the pilot conditioning section 621 includes a pilot conditioning blade 623, and the reaming section 631 includes a reaming blade 633, in which the pilot, pilot conditioning, and reaming blades 613, 623, and 633 are formed into a unitized blade structure. Further, the pilot and reaming blades 613 and 633 include PDC cutting elements 615 and 635, respectively, and the pilot conditioning blade includes one or more impregnated matrix cutting elements 625.

As shown in FIGS. 6A and 6B, the pilot conditioning blade 621 may be oriented or arranged in either a straight configuration or a helical configuration. In a straight configuration, as shown in FIG. 6B, the pilot conditioning blade 621 is substantially in-alignment with the pilot blade 613 and/or the reaming blade 635. Specifically, in this embodiment, the pilot conditioning blade 621 is substantially parallel with both the pilot blade 613 and the reaming blade 633, and all of the blade 613, 623, 633 are substantially perpendicular to a direction of rotation D of the drilling tool 601. A straight configuration of the pilot conditioning blade assists the stabilization of the drilling tool, in addition to reducing the torque about the reaming section.

In a helical configuration, as shown in FIG. 6A, the pilot conditioning blade 623 is substantially out-of-alignment with the pilot blade 613 and/or the reaming blade 635. Specifically, in this embodiment, the pilot conditioning blade 623 may neither be parallel with the pilot blade 613 and the reaming blade 633, nor perpendicular to the direction of rotation D of the drilling tool 601. A helical configuration of the pilot conditioning blade gives similar benefits to the straight configuration, however the helical configuration may also increase the bottom hole coverage and improve the bottom hole pattern of the blades of the drilling tool. Specifically, with a helical configuration, a pilot conditioning blade may be able to cover a larger radial section of the wellbore. As such, during drilling, before a first pilot conditioning blade completes cutting across a radial section of the wellbore during rotation, a second pilot conditioning blade may begin cutting across the same radial section of the wellbore.

Further, those having ordinary skill in the art will appreciate that, though the drilling tool is shown in FIGS. 6A and 6B with a straight configuration of the pilot and reaming blades, the present disclosure is not so limited, and each of the pilot and reaming blades may also be formed in a helical configuration. Further, in the helical configuration, the pilot conditioning blade is not limited to only a linear pilot conditioning blade; rather, the pilot conditioning blade may also be spiral or curved (e.g., non-linear) when oriented or arranged in the helical configuration.

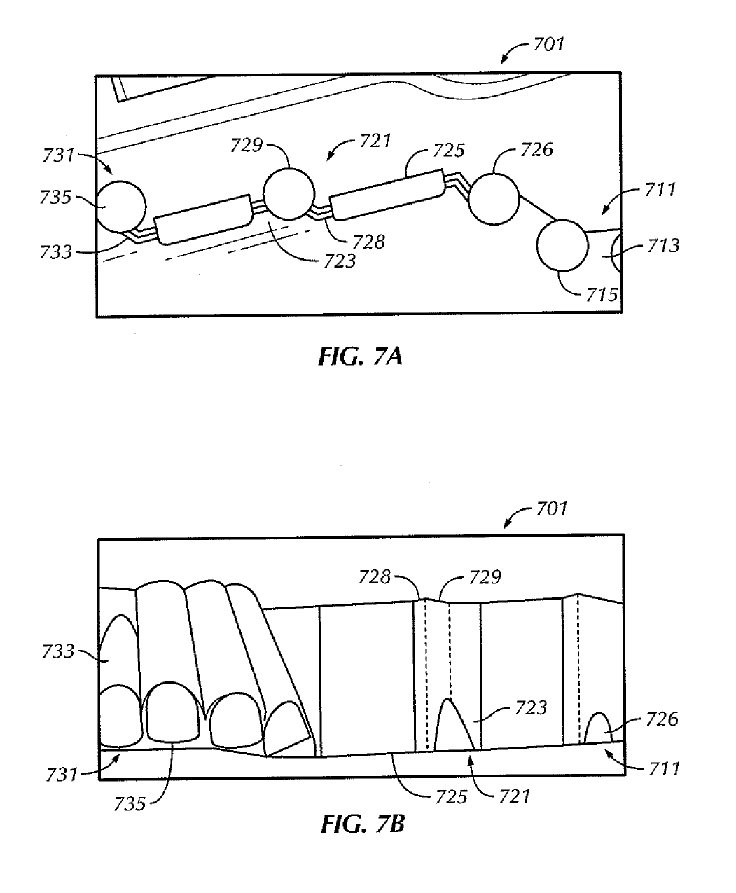

Referring now to FIGS. 7A and 7B, a profile view and a perspective view of a drilling tool 701 in accordance with embodiments disclosed herein is shown. Specifically, in FIG. 7A, a profile view of the drilling tool 701 is shown, and in FIG. 7B, a perspective view of the drilling tool 701 is shown. As similar to above, the drilling tool 701 includes a pilot section 711 having a pilot blade 713, a pilot conditioning section 721 having a pilot conditioning blade 723, and a reaming section 731 having a reaming blade 733. As also similar to above, the pilot blade 713 and the reaming blade 733 include. PDC cutting elements 715 and 735, respectively, and the pilot conditioning blade 723 includes one or more impregnated matrix cutting elements 725.

However, in FIGS. 7A and 7B, rather than only having a linear profile for the pilot conditioning blade 723 (as shown in FIGS. 5A and 5B), the pilot conditioning blade 723 in this embodiment includes one or more gage faces 728 and one or more tapered faces 729. As shown, one or more impregnated matrix cutting elements 725 may be disposed on or affixed to the one or more gage faces 728, and one or more cutting elements 726, such as PDC cutting elements, may be disposed on or affixed to the one or more tapered faces 720. Using both the gage face and the tapered face, the pilot conditioning blade may increase the cutting action of the cutting elements while still providing stability for the drilling tool.

As discussed above, the pilot conditioning section includes one or more impregnated matrix cutting elements. Matrix materials that may be used to form the matrix portion of the impregnated matrix cutting elements of the present disclosure may include hard particles, such as tungsten carbide, and a binder. Exemplary types of tungsten carbide include macrocrystalline tungsten carbide particles, carburized tungsten carbide particles, cast tungsten carbide particles, and sintered tungsten carbide particles. In other embodiments, non-tungsten carbides, oxides, or nitrides of vanadium, chromium, titanium, tantalum, niobium, and other carbides of the transition metal group may be used. A binder may also optionally include a binder powder that may, for example, include cobalt, nickel, iron, chromium, copper, molybdenum and other transition elements and their alloys, and combinations thereof, and/or an optional non-metallic binder such as organic wax or polyethylene glycol (PEG).

Further, abrasive particles that may be impregnated in the matrix material may be selected from synthetic diamond, natural diamond, reclaimed natural or synthetic diamond grit, cubic boron nitride (CBN), thermally stable polycrystalline diamond (TSP), or combinations thereof, which may all be uncoated or coated such as with a CVD or PVD retention coating.

Particularly, for the impregnated matrix cutting elements, diamond impregnated inserts, such as those described in U.S. Pat. No. 6,394,202 and U.S. Patent Publication No. 2006/0081402, frequently referred to in the art as grit hot pressed inserts (GHIs), may be mounted in sockets formed in the pilot conditioning blade of the pilot conditioning section. These inserts may then be mounted substantially perpendicular to the surface of the blade and affixed by brazing, adhesive, mechanical means such as interference fit, or the like, similar to use of GHIs in diamond impregnated bits, as discussed in U.S. Pat. No. 6,394,202. GHIs are commonly manufactured as cylindrical cutting elements, but those having ordinary skill in the art will appreciate that the present disclosure is not so limited, and impregnated matrix cutting elements of any shape known in the art may be used.

Alternatively, sockets may be inclined with respect to the surface of the blade so that the inserts may be oriented substantially in the direction of the rotation of the drilling tool, so as to enhance cutting. In yet another alternative embodiment, such inserts may be stacked within the pilot conditioning blade, along its periphery about the body of the drilling tool, in a substantially perpendicular fashion. For example, in one embodiment, the cutting elements of the pilot conditioning blade may be laid on the body of the drilling tool about the center axis, while other embodiments may have the cutting elements of the pilot conditioning blade laid side-by-side on the body of the drilling tool along the center axis. Further, one of ordinary skill in the art would appreciate that any combination of the above discussed cutting elements may be affixed to any of the ribs of the present disclosure.

Those having ordinary skill in the art will appreciate that, though the drilling tools shown all include a pilot section, a pilot conditioning section, and a reaming section, the present disclosure is not so limited, and a drilling tool may be formed having only the pilot conditioning section with one of the pilot section and the reaming section. For example, in one embodiment, a drilling tool may be formed having only a pilot conditioning section and a reaming section. In such an embodiment, the drilling tool may be configured to attach another tool at the end thereof, such as through another threaded connection, in which the pilot section may be attached to the drilling tool. Thus, a drilling tool may be formed only having the pilot conditioning section with one or more of the corresponding pilot and reaming sections.

Embodiments of the present disclosure may provide one or more of the following advantages. First, by including a cutting element formed of an impregnated matrix material disposed on a pilot conditioning section of a drilling tool, the drilling tool may have increased stability and reduced torque during drilling. Further, a drilling tool in accordance with embodiments disclosed herein may improve bottom hole conditioning of the wellbore while drilling. Specifically, by including a pilot conditioning section with an impregnated matrix cutting element, the pilot conditioning section may improve the bottom hole pattern of the wellbore and the cutting action of the pilot section during drilling. As such, the reaming section may have an improved wellbore to increase in diameter during drilling. Finally, a drilling tool in accordance with embodiments disclosed herein may increase the bottom hole coverage of the wellbore during drilling. Specifically, multiple blades may be included on the drilling tool, in which these blades will improve the coverage of the drilling of the drilling tool while not sacrificing stability or increasing torque.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A drilling tool, comprising:
a tool body comprising a connection at an upper end thereof;
a reaming section comprising reaming blades distributed azimuthally around the tool body, wherein the reaming blades are configured to increase the diameter of a wellbore from a pilot hole diameter; and
a pilot conditioning section comprising pilot conditioning blades distributed azimuthally around the tool body and disposed below the reaming section, wherein at least one of the pilot conditioning blades comprises at least one cutting element formed of an impregnated matrix material and an outermost extent of the at least one cutting element from a central axis of the tool body is at least half of the pilot hole diameter.

2. The drilling tool of claim 1, wherein the tool body comprises a second connection at a lower end thereof.

3. The drilling tool of claim 1, further comprising a pilot section located below the pilot conditioning section and comprising pilot blades.

4. The drilling tool of claim 3, wherein the pilot blades, the pilot conditioning blades, and the reaming blades are formed in a unitized blade structure.

5. The drilling tool of claim 3, wherein the pilot section is configured to form a wellbore having the pilot hole diameter, and wherein the reaming section is configured to form a wellbore having a reaming hole diameter.

6. The drilling tool of claim 1, wherein the pilot conditioning section comprises at least one of a straight configuration and a helical configuration.

7. The drilling tool of claim 1, wherein at least one of the pilot conditioning blades comprises a gage face and a tapered face.

8. The drilling tool of claim 7, wherein the at least one cutting element is disposed on the gage face, and further comprising a PDC cutting element disposed on the tapered face.

9. The drilling tool of claim 7, wherein the tapered face is disposed below the gage face.

10. The drilling tool of claim 1, wherein at least one of the pilot conditioning blades comprises a plurality of gage faces and a plurality of tapered faces.

11. The drilling tool of claim 1, wherein the outermost extent of the at least one cutting element is no larger than about 10 percent of the at least half of the pilot hole diameter.

12. The drilling tool of claim 1, wherein at least one of the pilot conditioning blades comprises a tapered section at an angle no larger than about 10 degrees.

13. The drilling tool of claim 1, wherein the at least one cutting element formed of an impregnated matrix material is a diamond impregnated insert.

14. A drilling tool having a tool body with a central axis extending therethrough, the tool comprising:
a pilot section comprising pilot blades distributed azimuthally around the tool body, wherein the pilot blades define a pilot diameter;
a pilot conditioning section comprising pilot conditioning blades distributed azimuthally around the tool body and disposed above the pilot section, wherein the pilot conditioning blades comprise at least one cutting element formed of a matrix material and an abrasive material, wherein the pilot conditioning blades define a pilot conditioning diameter; and
a reaming section comprising reaming blades distributed azimuthally around the tool body, wherein the reaming blades define a reaming diameter;
wherein the pilot conditioning diameter is between the range of, and including, the pilot diameter and a pass-through diameter.

15. The drilling tool of claim 14, wherein the at least one cutting element is a grit hot pressed insert.

16. The drilling tool of claim 14, wherein at least one of the pilot blades, pilot conditioning blades, and reaming blades is formed into a unitized blade structure.

17. A drilling tool with a central axis extending therethrough, the tool comprising:
a pilot section configured to form a wellbore with a pilot hole diameter;
a reaming section configured to increase the diameter of the wellbore to a reaming hole diameter, wherein the reaming section is disposed above the pilot section; and
a pilot conditioning section disposed between the pilot section and the reaming section, wherein the pilot conditioning section comprises a cutting element formed of an impregnated matrix material and is configured to engage the wellbore with a pilot conditioning hole diameter between and including the reaming hole diameter and the pilot hole diameter.

18. The drilling tool of claim 17, wherein the pilot conditioning section comprises at least one pilot conditioning blade with the cutting element disposed thereon.

19. The drilling tool of claim 17, wherein the pilot section comprises pilot blades configured to form the wellbore with a pilot hole diameter, wherein the reaming section comprises reaming blades configured to increase the diameter of the wellbore to a reaming hole diameter.

20. The drilling tool of claim 19, wherein the pilot conditioning section comprises pilot conditioning blades configured to engage the wellbore with the pilot conditioning hole diameter, wherein the cutting element is disposed on at least one of the pilot conditioning blades.

21. The drilling tool of claim 20, wherein at least one of the pilot blades, pilot conditioning blades, and reaming blades is formed into a unitized blade structure.

22. A method of forming a drilling tool for drilling through a formation to form a wellbore, the method comprising:
providing a body for the drilling tool, wherein the body includes a pilot conditioning section having at least one pilot conditioning blade and a reaming section having at least one reaming blade;
affixing to the reaming blade at least one cutting element; and
affixing to the pilot conditioning blade at least cutting element formed of an impregnated matrix material.

23. The method of claim 22, wherein the at least one cutting element formed of an impregnated matrix material is affixed to the pilot conditioning blade by one of brazing, adhesive, and interference fit.

24. The method of claim 22, wherein the at least one cutting element formed of an impregnated matrix material is a grit hot insert.
